(19) United States
(12) Patent Application Publication
(10) Pub. No.: US 2007/0076286 A1
(43) Pub. Date: Apr. 5, 2007

(54) Electrochromic device comprising protective inorganic solid electrolyte film and manufacturing method thereof

(76) Inventors: Yungeun Sung, Anyang-City (KR); Sungjong Yoo, Seoul (KR); Juwan Lim, Saha-gu (KR)

Correspondence Address: LAW OFFICES OF ALBERT WAI-KIT CHAN, LLC, WORLD PLAZA, SUITE 604, 141-07 20TH AVENUE, WHITESTONE, NY, 11357, US

(21) Appl. No.: 11/367,646

(22) Filed: Mar. 3, 2006

(30) Foreign Application Priority Data
Sep. 23, 2005 (KR) 10-2005-0088784
Dec. 13, 2005 (KR) 10-2005-0122327

(51) Int. Cl. G02F 1/15

(52) U.S. Cl. 359/265

(57) ABSTRACT

The present invention relates to an electrochromic device comprising a protective inorganic solid electrolyte film and a manufacturing method thereof. The electrochromic device comprises an electrochromic layer, an electrolyte layer and a counterelectrode layer, in which an inorganic solid electrolyte film as a protective layer is provided on the interface between the electrolyte layer and at least one layer of the electrochromic layer and the counterelectrode layer. The electrochromic device has excellent durability, fast bleaching and coloring response rates, and excellent memory effect with time. Accordingly, it can be advantageously applied to a commercial process for manufacturing electrochromic devices.

### BACKGROUND OF THE INVENTION

1. Field of the Invention

The present invention relates to an electrochromic device having excellent electrochromic properties and high durability, as well as a manufacturing method thereof.

2. Background of the Related Art

The development of windows with energy efficiency using electrochromism, which is a phenomenon where color changes depending on the potential of an applied electric field, can contribute to fossil fuel emission reduction and energy saving through the utilization of alternative energy and greatly contribute to global environment preservation. Also, since the development of a new concept of windows whose function can be actively adjusted allows an increase in the quality of life through the improvement of residential culture and office environment, many studies on these windows are being conducted.

Electrochromism is applied to spectacles, mirrors, windows such as smart windows, smart cards, price labels, and displays such as mobile phones (C. G. Granqvist, Handbook of Inorganic Electrochromic Materials, Elsevier, Amsterdam, 1995; P. J. Gellings and H. J. M. Bouwmeester, C. G. Granqvist (Eds.), The CRC Handbook of Solid State Electrochemistry, CRC press, Boca Raton, 1997, Chap. 16, p. 587).

Electrochromic devices have components similar to those of battery cells and comprise thin layers, including electrochromic layer (positive electrode)/electrolyte (Li⁺, H⁺)/counterelectrode layer (negative electrode). A brief explanation of the principle of electrochromism is as follows. When cations and electrons, such as Li⁺ or H⁺, are injected into an electrochromic layer made of reducing coloration material (WₓO_{y}, MoₓO_{y}, etc.), the layer will be colorized, and when the cations are released, the layer will be transparent. On the other hand, when cations and electrodes, such as Li⁺ or H⁺, are released from a counterelectrode layer made of oxidative coloration material (VₓO_{y}, NiₓO_{y}, etc), the counterelectrode layer will be colorized, and when then cations are injected, the counterelectrode layer will be transparent.

FIG. 4a is a cross-sectional view showing the structure of an electrochromic device according to the prior art. As shown in FIG. 4a, the prior electrochromic device comprises a glass substrate, and a transparent electrode layer, a counterelectrode layer, an electrolyte layer, an electrochromic layer and a transparent electrode layer, which are sequentially formed on the glass substrate.

However, the prior electrochromic device has a stability problem, because the reversibility of the intercalation and deintercalation of ions ((H⁺, Li⁺, etc.) is broken due to the contact between the layers (electrochromic layer or counterelectrode layer) and the electrolyte layer.

For example, tungsten oxides which have been widely studied as electrochromic materials can cause an irreversible chemical reaction with lithium ions intercalated in an electrochromic device, so that lithium ions will be trapped in each layer of the electrochromic device, whereby each layer of the electrochromic device will be degraded, and cleaved into thin layers to deteriorate the properties of the electrochromic device, and modified into a material which can no longer perform electrochromism in a fast time or can cause electrical leakage from the device, thus losing function as an electrochromic device (N. J. Dudney, J. Power Sources, 89 (2000) 17; G. Leftheriotis, S. Papaefthimiou, P. Yianoulis, Solar Energy Materials and Solar Cells, 83 (2004) 115; Tetsu Oi, Katsuki Miyauchi, Keiichi Uehara, J. Appl. Phys., 53 (1982) 1823).

As described above, the prior electrochromic device has the problems of short lifecycle and irreversible electrochemical reaction, and accordingly, there is an urgent need for the development of a novel electrochromic device having high durability and excellent electrochromic properties.

### SUMMARY OF THE INVENTION

It is an object of the present invention to provide an electrochromic device having improvements in device properties, such as durability, bleaching response time and coloring response time, and memory effect.

To achieve the above object, in one aspect, the present invention provides an electrochromic device comprising an electrochromic layer, an electrolyte layer and a counterelectrode layer, in which an inorganic solid electrolyte layer as a protective layer is provided on the interface between the electrolyte layer and at least one layer of the eletrochromic layer and the counterelectrode layer.

In another aspect, the present invention provides a method for manufacturing an electrochromic device, comprising the steps of:

a) depositing an electrochromic layer on a substrate having a transparent electrode layer formed thereon, and then depositing an inorganic solid electrolyte on the electrochromic layer by a sputtering process so as to form a protective layer;

b) depositing a counterelectrode layer on a substrate having a transparent electrode layer formed thereon and then depositing an inorganic solid electrolyte on the counterelectrode layer by a sputtering process so as to form a protective layer; and

c) injecting an electrolyte between the electrochromic layer and the counterelectrode layer, which comprise the protective inorganic solid electrolyte films formed in the steps a) and b), respectively, so as to form an electrolyte layer.

### BRIEF DESCRIPTION OF THE DRAWINGS

FIGS. 1a and 1b are scanning electron microscope (SEM) photographs showing the comparison of cross sections between a tungsten oxide thin film of Comparative Example having no protective inorganic solid electrolyte film, and a tungsten oxide thin film of Example including a protective inorganic solid electrolyte film (LiPON).

FIGS. 2a and 2b show changes in voltage and current after 100 cycles for a tungsten oxide thin film of Comparative Example having no protective inorganic solid electrolyte film, and a tungsten oxide thin film of Example having a protective inorganic solid electrolyte film (LiPON).

FIGS. 3a and 3b shows changes in optical transmittance with pulse voltage for a tungsten oxide thin film of Comparative Example having no protective inorganic solid electrolyte film, and a tungsten oxide thin film of Example having a protective inorganic solid electrolyte film (LiPON).

FIGS. 4a and 4 b show a cross-sectional view of an electrochromic device of Comparative Example having no protective inorganic solid electrolyte film, and an electrochromic device of Example including a protective layer of an inorganic solid electrolyte (LiPON), respectively.

FIG. 5 is a schematic diagram showing a test system for measuring the optical transmittance of an electrochromic device in real time.

FIGS. 6a and 6b show changes in transmittance with pulse voltage for an electrochromic device of Comparative Example having no protective inorganic solid electrolyte film, and an electrochromic device of Example including a protective inorganic solid electrolyte film (LiPON), respectively.

FIG. 7 shows the comparison of memory effect as a function of time between an electrochromic device of Comparative Example having no protective inorganic solid electrolyte film, and an electrochromic device of Example including a protective inorganic solid electrolyte film (LiPON).

FIG. 8 is a scanning electron microscope (SEM) photograph showing the comparison between tungsten oxide thin films having protective inorganic solid electrolyte layers formed to have various thicknesses.

FIG. 9 shows the correlation between the thickness of a protective inorganic solid electrolyte film (LiPON) and a change in the transmittance of a tungsten oxide thin film with pulse voltage.

FIG. 10 shows the correlation between the thickness of an inorganic solid electrolyte layer (LiPON) and a reduction change in the transmittance of a tungsten oxide thin film according to pulse voltage.

FIG. 11 shows the correlation between the thickness of an inorganic solid electrolyte layer (LiPON) and the bleaching response time and coloring response time of a tungsten oxide thin film.

### DETAILED DESCRIPTION OF THE PREFERRED EMBODIMENT

Hereinafter, the present invention will be described in detail.

The present invention is characterized by using an inorganic solid electrolyte layer as a protective film on the interface between an electrolyte layer and at least one layer of an electrochromic layer and a counterelectrode layer.

Electrochromic devices utilize a characteristic in that a change in an optical structure occurs by the transfer of ions, leading to a change in color. For this reason, the interface between an electrochromic layer or a counterelectrode layer and an electrolyte layer acts as a very important variable to improve durability.

The electrochromic device according to the present invention comprises an inorganic solid electrolyte film as a protective film on an interface with the electrochromic layer or the counterelectrode layer. Thus, in the inventive electrochromic device, the intercalation and deintercalation of cations, such as lithium ions, in the electrolyte layer, stably occur, and the degradation and cracking of the electrochromic layer caused by the electrolyte are prevented, leading to improvements in device properties, such as durability, bleaching and coloring response rates, and memory effect.

The protective film made of an inorganic solid electrolyte, used in the present invention, is made of lithium phosphorus oxynitride (hereinafter, “LiₓPO_{y}N_{z}”) . A preferred case is where x in LiₓPO_{y}N_{z}, is 3.3-3.6, y is 3.3-3.8, and z is 0.24-0.69. LiₓPO_{y}N_{z} is an electrolyte developed by J. B. Bates et al., members of Oak Ridge National Laboratory, USA (see J. B. Bates, G. R. Gruzalski, N. J. Dudney, and C. F. Luck, Proc. 35th Power Sources Symp. (1992) p. 337; J. B. Bates, N. J. Dudney, G. R. Gruzalski, R. A. Zuhr, A. Choudhury, C. F. Luck, and J. D. Robertson, J. Power Sources, 43-44, 103 (1993)), and has characteristics in that it is stable even in wide electrical windows reaching 5.5 V, and provides a very excellent contact between both electrodes, leading to an improvement in charge and discharge characteristics and a reduction in interfacial resistance.

A method for forming the inorganic solid electrolyte film as the protective film used in the present invention is not specifically limited and can be performed using known thin-film growth technologies used in semiconductor manufacturing processes. Examples of the method, which can be used in the present invention, include a radio-frequency magnetron sputtering method, a thermal evaporator method, chemical vapor deposition (“CVD”), PLD (pulsed laser deposition), a sol-gel method and the like. In the present invention, a protective inorganic solid electrolyte film was deposited on an electrochromic layer or a counterelectrode layer by radio-frequency magnetron sputtering method, and the method is particularly preferable in that it can provide a high quality of deposited material, since the transformation of deposited material into a vapor phase is not a chemical or thermal process, but rather a physical momentum exchange process, and that it has high simplicity and reproducibility.

The inorganic solid electrolyte layer as the protective film used in the present invention preferably has a thickness of 30-100 nm, and more preferably 30-50 nm. The thickness of the inorganic solid electrolyte layer is highly important in the durability and electrochromic properties of the inventive electrochromic device. Namely, if the inorganic solid electrolyte layer has a thickness less than 30 nm, it will have a very insignificant effect on the improvement of durability, and if it has a thickness over 100 nm, it will provide an improvement of durability, but cause significant reduction in bleaching response time and coloring response time, which are important properties in electrochromic devices. Accordingly, by forming the inorganic solid electrolyte layer in the thickness within the above-specified range, it is possible to realize fast bleaching response and coloring response rates and an increase in the durability of the electrochromic device simultaneously.

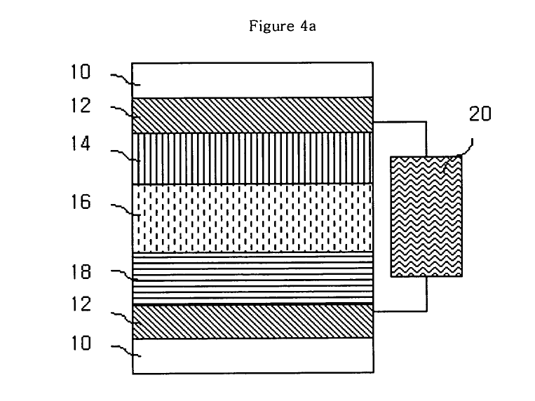

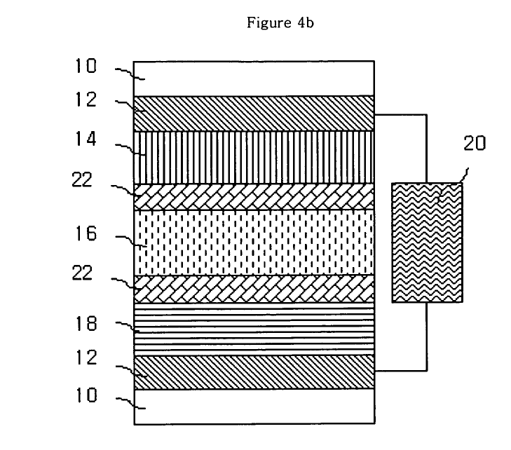

As shown in FIG. 4b, the electrochromic device according to the present invention comprises a transparent electrode layer 12 formed below a first substrate 10, a counterelectrode layer 14 formed below the transparent electrode layer 12 to have a given shape, a second transparent electrode layer 12a formed above a second substrate 10a, and an electrochromic layer 18 formed above the transparent electrode layer 12a to have a given shape, in which an electrolyte layer 16 is provided between the electrochromic layer 18 and the counterelectrode layer 14. Also, the electrochromic layer 18 and the counterelectrode layer 14 face each other.

In the present invention, the interface between the electrolyte layer 16 and at least one layer of the electrochromic layer 18 and the counterelectrode layer 14 includes an inorganic solid electrolyte film 22 as a protective film.

Specifically, an electrochromic device according to a first embodiment of the present invention may comprise, with respect to an electrolyte layer, a counterelectrode layer, a transparent electrode layer and a substrate above the electrolyte layer, and an inorganic solid electrolyte layer, an electrochromic layer, a transparent electrode layer and a substrate below the electrolyte layer.

An electrochromic device according to a second embodiment of the present invention may comprise, with respect to an electrolyte layer, an inorganic solid electrolyte film, a counterelectrode layer, a transparent electrode layer and a substrate above the electrolyte layer, and an electrochromic layer, a transparent electrode layer and a substrate below the electrolyte layer.

An electrochromic device according to a third embodiment of the present invention may comprise, with respect to an electrolyte layer 16, an inorganic solid electrolyte film 22, a counterelectrode layer 14, a transparent electrode layer 12 and a substrate 10 above the electrolyte layer 16, and an inorganic solid electrolyte film 22, an electrochromic layer 18, a transparent electrode layer 12 and a substrate 10 below the electrolyte layer 16 (see FIG. 4b).

The substrate used in the electrochromic device according to the present invention may be a conventional glass substrate, and the kind thereof is not specifically limited. The transparent electrode layers may be made of any material that is used for a transparent electrode layer in the manufacturing of semiconductor devices and battery cells. For example, the transparent electrode layers are preferably made of ITO, ZnO or IZO, and more preferably ITO. If the conventional glass substrate is used, it will preferably be coated with silicon oxide (SiO₂) to prevent sodium in the glass substrate from being diffused to the transparent electrodes.

An electrolyte useable in the electrolyte layer is not specifically limited in the kind and type thereof, and may be any material generally used in the manufacturing of electrochromic devices, such as a lithium ion-, hydrogen ion- or calcium ion-conducting electrolyte. Preferably, it may be a lithium ion-conducting electrolyte, such as LiClO₄/PC, or LiPF₆/PC/co-solvent. More preferably, it may be one or a mixture of two or more selected from lithium ion-conducting electrolytes obtained by dissolving lithium ion salts, such as lithium perchlorate (LiClO₄), lithium hexafluorophosphate (LiPF₆), lithium tetrafluoroborate (LiBF₄), lithium tetrafluoromethane sulfonate (LiCF₃SO₃), and lithium hexafluoroarsenate (LiAsF₆), in liquid solvents, such as acetonitrile, γ-butyrolactone, diethylether, dimethylsulfoxide, 1,3-dioxolane, ethylene carbonate, methylformate, 2-methyltetrahydrofuran, 3-methyloxazolidin-2-one, propylene carbonate, sulfolane, tetrahydrofuran, and the like. The liquid lithium ion-conducting electrolytes have an advantage in its diffusion into the medium of each of both electrodes by voltage gradient and thus provide a reduction in response time, an important factor for electrochromic devices. Among these electrolytes, a solution of LiClO₄ in polycarbonate (PC) was used in the present invention.

In the present invention, electrochromic materials used for the counterelectrode layer and the electrochromic layer may be inorganic ECD (IECD) and organic ECD (OECD) and are not specifically limited. Preferably, those selected from inorganic ECDs may be used as the materials of the counterelectrode layer and the electrochromic layers. Specifically, the electrochromic layer in the present invention may be made of, e.g., WₓO_{y}, MoₓO_{y}, TaₓO_{y}, NbₓO_{y}, TiₓO_{y}, or CrₓO_{y}, wherein x is 1-3, and y is 1-6. The counterelectrode layer may be made of e.g., VₓO_{y}, NiₓO_{y}, IrₓO_{y}, FeₓO_{y}, MnₓO_{y}, RhₓO_{y}, or CoₓO_{y}, wherein x is 1-3, and y is 1-6. More preferably, WO₃ for the electrochromic layer and V₂O₅ for the counterelectrode layer are used in the present invention.

Hereinafter, a manufacturing method of an electrochromic device according to the present invention will be described in detail with reference to the accompanying drawings in order to allow a person skilled in the art to easily practice the present invention.

A method for manufacturing an electrochromic device according to the present invention comprises the steps of depositing an inorganic solid electrolyte film on an electrochromic layer and depositing an inorganic solid electrolyte film on a counterelectrode layer. FIG. 4b shows one example of an electrochromic device according to the present invention.

The inventive method for manufacturing the electrochromic device comprises the steps of: a) depositing an electrochromic layer on a first substrate having a transparent electrode layer formed thereon and then depositing an inorganic solid electrolyte on the electrochromic layer by a sputtering process so as to form a protective film; b) depositing a counterelectrode layer on a second substrate having a transparent electrode layer formed thereon and then depositing an inorganic solid electrolyte on the counterelectrode layer by a sputtering process so as to form a protective film; and c) injecting an electrolyte between the electrochromic layer and the counterelectrode layer, which comprise the protective inorganic solid electrolyte films formed in the steps a) and b), respectively, so as to form an electrolyte layer.

The inventive method may additionally comprise, before the step of injecting the electrolyte between the two electrode layers of the electrochromic device, the steps of injecting electrolyte ions into the electrochromic layer or the electrochromic layer including the protective film to colorize the electrochromic layer, and releasing electrolyte ions from the counterelectrode layer or the counterelectrode layer including the protective layer to bleach the counterelectrode layer. Alternatively, the inventive manufacturing method may additionally comprise, before the steps of injecting the electrolyte between the two electrode layers of the electrochromic device, the steps of releasing electrolyte ions from the electrochromic layer or the electrochromic layer including the protective film to bleach the electrochromic layer, and injecting electrolyte ions into the counterelectrode layer or the counterelectrode layer including the protective layer to bleach the counterelectrode layer. These steps adjust the charge balance between both the electrodes to make the drive of the electrochromic device stable.

In one embodiment of the present invention, an upper glass substrate on which an inorganic solid electrolyte protective film 22 and a counterelectrode layer 14 have been deposited, was placed opposite to a lower glass substrate 10 on which an inorganic solid electrolyte protective film 22 and a electrochromic layer 18 have been deposited, and a spacer was placed between the two glass substrates including the counterelectrode layer 14 and the electrochromic layer 18, respectively, so as to form a given gap between the glass substrates. Then, after the four sides of each of the substrates were encapsulated with an encapsulant such as epoxy while leaving a space into which an electrolyte solution could be injected (not shown), a liquid electrolyte 16 was injected between the substrates. When an electric field is applied to the upper and lower electrodes after forming the electrolyte between the upper and lower glass substrates, lithium ions and the like contained in the electrolyte 16 will migrate and react with electrochromic material WO₃ to show electrochromic effects.

Hereinafter, the present invention will be described in detail by examples. It is to be understood, however, that these examples are for illustrative purpose only and are not construed to limit the scope of the present invention.

### COMPARATIVE EXAMPLE 1

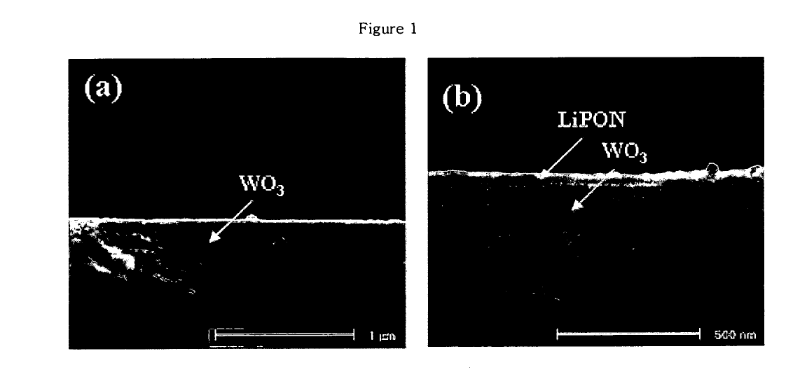

On glass substrates each having a transparent electrode (ITO) coated thereon while interposing 30-nm-thick silicon oxide (SiO₂) therebetween, tungsten oxide (WO₃) and vanadium oxide (V₂O₅) were deposited, respectively, by an R—F magnetron sputtering process, so as to form thin films consisting of substrate (glass)/transparent electrode layer (ITO)/electrochromic layer (WO₃) and substrate (glass)/transparent electrode layer (ITO)/counterelectrode layer (V₂O₅), respectively. Then, a liquid electrolyte (LiClO₄/PC) was injected between the two electrodes (i.e., electrochromic layer and counterelectrode layer) of the thin films so as to manufacture an electrochromic device consisting of substrate (glass)/transparent electrode layer (ITO)/counterelectrode layer (V₂O₅)/electrolyte layer (LiClO₄/PC)/electrochromic layer (WO₃) /transparent electrode layer (ITO)/substrate (glass) (see FIG. 4a). Herein, the deposition conditions of each of the materials were the same as those described in Examples below. FIG. 1a is a scanning electron microscope (SEM) photograph showing the cross section of the tungsten oxide thin layer (WO₃) having no protective film of an inorganic solid electrode, formed in Comparative Example.

### EXAMPLE 1

On glass substrates each having a transparent electrode (ITO) coated thereon while interposing 30-nm-thick silicon oxide (SiO₂) there between, WO₃ was deposited on the transparent electrode (ITO) in a vacuum of 10 mTorr at room temperature under an argon atmosphere at an RF power of 100 W for 90 minutes. The deposition rate of the tungsten oxide was 4.4 nm/min. WO₃ was deposited to a thickness of about 400 nm. Then, on the WO₃ layer, LiPON (Li_{3.3}PO_{3.8}NO_{0.22}, United Vacuum & Materials (UVM)) was deposited. A LiPON target was used as an inorganic solid electrolyte, and the distance between the transparent electrode substrate and the LiPON target was 25 cm. The pressure before starting the experiment was 2.5×10⁻⁶ Torr, and the sputtering operation was carried out in a pressure of 10×10⁻³ Torr at room temperature in a nitrogen atmosphere at a power of 100 W for 30 minutes. The deposition rate of LiPON was 1.6 nm/min, and as shown in FIG. 1b, LiPON was deposited to a thickness of about 50 nm, so as to form an element consisting of substrate (glass)/transparent electrode layer (ITO)/electrochromic layer (WO₃)/inorganic solid electrolyte protective film (LiPON). FIG. 1b is a scanning electron microscope photograph shows the electrochromic layer (WO₃) and the inorganic solid electrolyte protective film (LiPON), deposited by the R—F magnetron sputtering according to the present invention.

Meanwhile, V₂O₅ was deposited on the transparent electrode (ITO) in an atmosphere of a mixture of argon and oxygen (1:1) at a power of 200 W for 180 minutes. LiPON was deposited on the V₂O₅ layer so as to form an element consisting of substrate (glass)/transparent electrode layer (ITO)/counterelectrode layer (V₂O₅)/inorganic solid electrolyte protective film (LiPON). Next, a liquid electrolyte (LiClO₄/PC) was injected between the two elements so as to manufacture an electrochromic device consisting of substrate (glass)/transparent electrode layer (ITO)/counterelectrode layer (V₂O₅)/protective inorganic solid electrolyte film (LiPON)/electrolyte layer (LiClO₄/PC)/protective inorganic solid electrolyte film (LiPON)/electrochromic layer (WO₃)/transparent electrode layer (ITO)/substrate (glass) (see FIG. 4b). Before injecting the liquid electrolyte between the two electrolyte layers, the electrochromic layer 18 was colorized by injecting lithium ions, and the counterelectrode layer 14 was bleached by releasing lithium ions. This was performed to adjust the charge balance between both the electrodes and to make the drive of the electrochromic device stable. Thus, the electrochromic device is in an initial state where the electrochromic layer and the counterelectrode layers were colorized.

### EXAMPLE 2

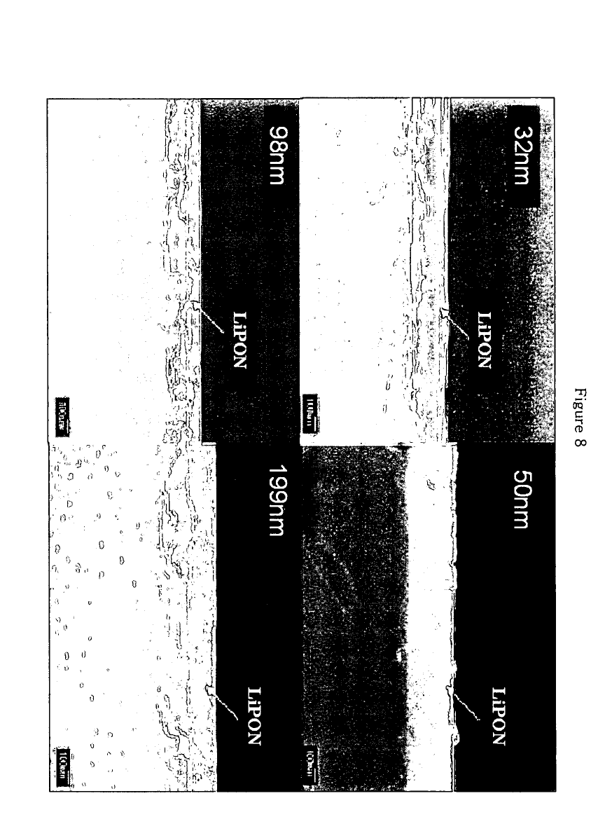

The procedure of Example 1 was repeated except for RF power and deposition time, thus manufacturing devices consisting each of substrate (glass)/transparent electrode layer (ITO)/electrochromic layer (WO₃)/protective inorganic solid electrolyte film (LiPON), in which the thicknesses of the inorganic solid electrolyte films of the devices were 10 nm, 32 nm, 50 nm, 98 nm, and 199 nm, respectively. The thickness of each of the inorganic solid electrolyte films increased with increases in RF power and deposition time, and a scanning electron microscope photograph of the electrochromic layer (WO₃) and the protective inorganic solid electrolyte film (LiPON) in each of the devices is shown in FIG. 8.

### TEST EXAMPLE 1

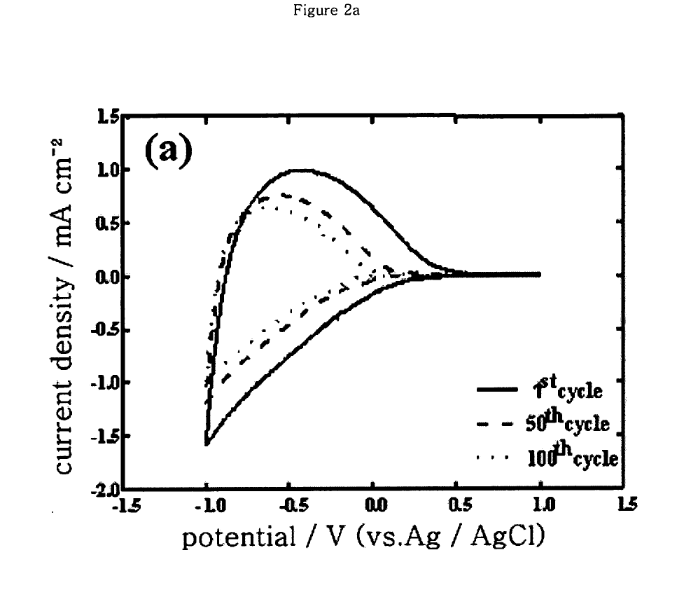

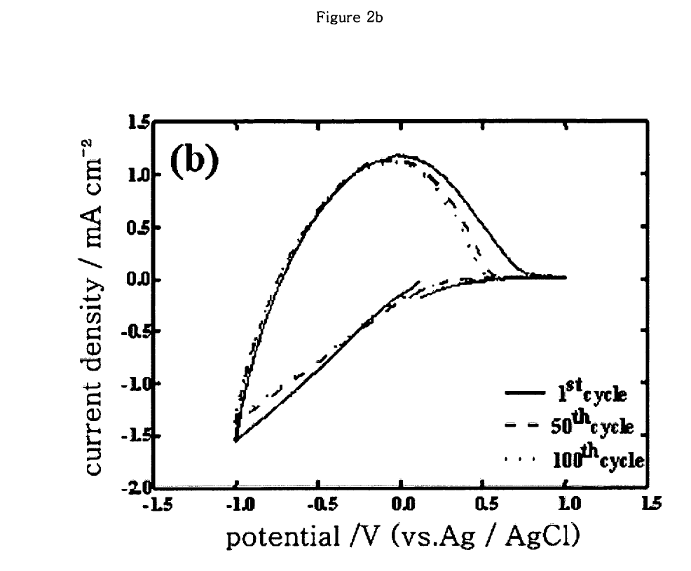

The tungsten oxide thin film of Comparative Example having no protective inorganic solid electrolyte film (i.e., a device consisting of substrate (glass)/transparent electrode layer (ITO)/electrochromic layer (WO₃)) and the tungsten oxide thin film of Example 1 comprising the protective inorganic solid electrolyte film (i.e., a device consisting of substrate (glass)/transparent electrode layer (ITO)/electrochromic layer (WO₃)/protective inorganic solid electrolyte film (LiPON)) were comparatively examined for electrochemical stability in an electrolyte (LiClO₄/PC). Each of the devices was used as a working electrode, and Pt was used as a counter electrode, and Ag/AgCl (sat. KCl) was used as a reference electrode. Each of the working electrodes was placed in an electrolyte of 1 M LiClO₄/PC and then applied with voltage by cyclic voltammetry from −1 V to 1 V at a scan rate of 20 mV/s, and changes in voltage and current were measured in Autolab PGSTAT30 Potentiostat/Galvanostat. The results are shown in FIGS. 2a and 2b. As shown in FIG. 2a, it can be seen that the tungsten oxide thin film of Comparative Example having no protective inorganic solid electrolyte film showed a gradual decrease in current value with the progression of cycles. This is believed to be because charges are trapped due to an irreversible electrochemical reaction between the intercalated/deintercalated lithium ions and the electrochromic layer, and also lithium ions are trapped by a small amount of water present in the liquid electrolyte of the electrochromic device. Unlike the device of Comparative Example, it could be observed that the tungsten oxide thin film including the protective inorganic solid electrolyte film as shown in FIG. 2b had very stable current values during the progression of 100 cycles by cyclic voltammetry. As a result, it could be found that, in the case of the inventive device comprising the protective inorganic solid electrolyte film, the electrochromic layer is not degraded or cracked by the electrolyte, unlike the prior device.

### TEST EXAMPLE 2

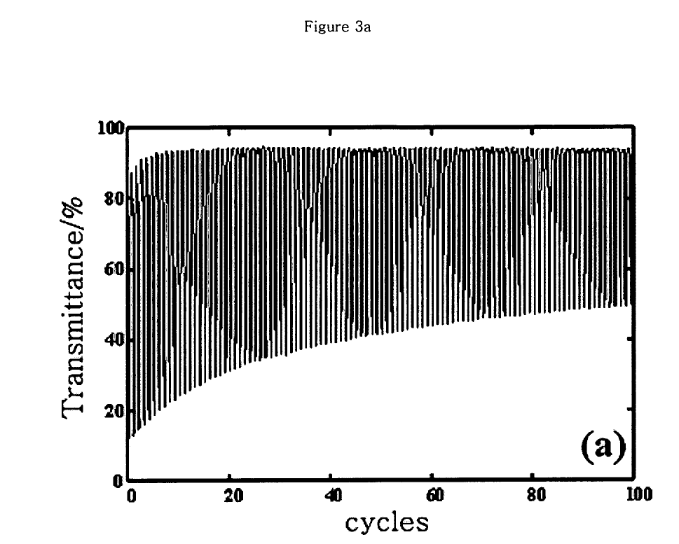

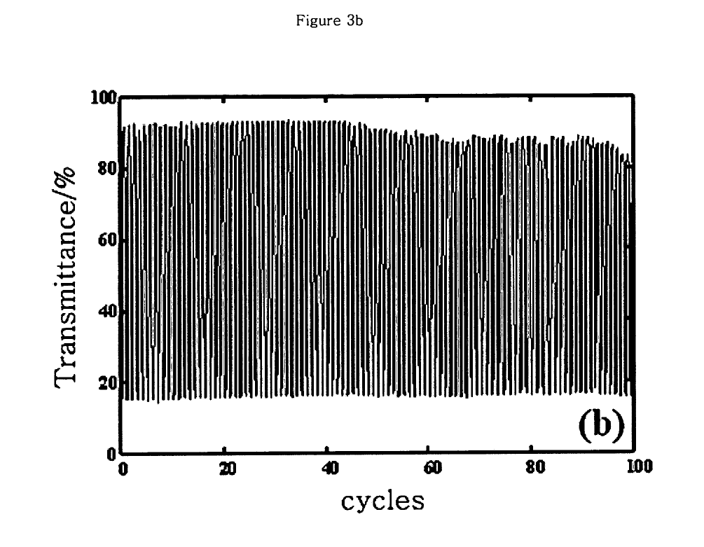

Each of the devices according to Comparative Example and Example was measured for a change in optical transmittance for 100 cycles by pulse voltammetry, and the results are shown in FIG. 3. Specifically, each of the devices was used as a working electrode and applied with pulse voltage from −2.5 V to 1.5 V for 30 seconds, while a change in optical transmittance was monitored in-situ by a He—Ne laser (633 nm). As shown in FIG. 3a, in the case of the device according to Comparative Example, a change in optical transmittance between coloration and bleaching was gradually decreased with the progression of cycles. This is because lithium ions are trapped in tungsten oxide, so that an irreversible reaction continuously occurs. On the other hand, as shown in FIG. 3b, the device according to Example showed a stable and constant change in optical transmittance (16%-90%). As a result, it could be found that, the protective inorganic solid electrolyte film in the inventive device prevented a phenomenon where the electrochromic layer would be cracked or degraded or cleaved into thin layers, leading to an improvement in the durability of the device.

Also, the coloration efficiencies (CE) of the devices were measured and the results were 37 cm²/C (Comparative Example) and 54 cm²/C(Example). Herein, the term “coloration efficiency” is defined as log(T bleaching/T coloration)/Q, wherein the term “T bleaching” and the term “T coloration” refer to optical transmittances when bleached and colored, respectively, and “Q” refers to the amount of electric charges used per unit area during coloring process. The bleaching response time and coloring response time of the device according to Comparative Example were 12 seconds and 17 seconds, respectively, and the bleaching response time and coloring response time of the device according to Example were 6.5 seconds and 13 seconds, respectively. These devices were faster in bleaching response time than coloring response time. This is because the electrical conductivity of the bleached tungsten oxide thin film is higher than that of the colorized tungsten oxide thin film. Also, it can be seen that the electrochromic device of Example having the protective inorganic solid electrolyte film is faster in electrochromic response time than that of the device of Comparative Example, and this is believed to be because ions in the electrolyte can be easily diffused by the protective film.

### TEST EXAMPLE 3

The electrochromic device of Comparative Example consisting of substrate (glass)/transparent electrode layer (ITO)/counterelectrode layer (V₂O₅)/electrolyte layer (LiClO₄/PC)/electrochromic layer (WO₃)/transparent electrode layer (ITO)/substrate (glass) as shown in FIG. 4a and the electrochromic device of Example 1 consisting of substrate (glass)/transparent electrode layer (ITO)/counterelectrode layer (V₂O₅)/protective inorganic solid electrolyte film (LiPON)/electrolyte layer (LiClO₄/PC)/protective inorganic solid electrolyte film (LiPON)/electrochromic layer (WO₃)/transparent electrode layer (ITO)/substrate (glass) as shown in FIG. 4b were comparatively examined for optical transmittance and electrochemical properties.

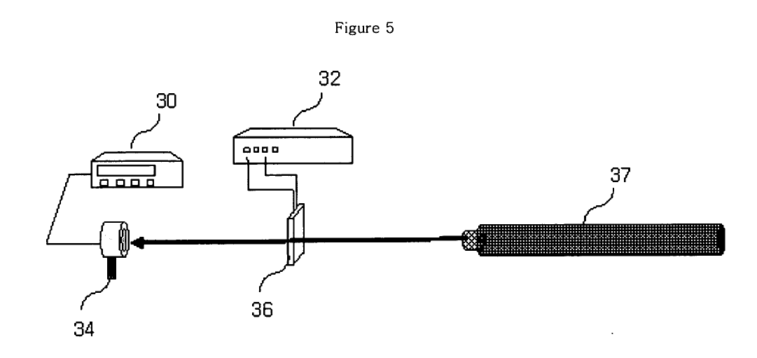

FIG. 5 is a schematic diagram showing a test system used in comparatively measuring the optical transmittance and electrochemical properties of the devices. As shown in FIG. 5, a potential device 32 was connected to both the electrodes of each electrochromic device 36, and the optical transmittance of each electrochromic device was measured with a photometer 30 and a photoreader 34 using a He—Ne laser 37. The advantage of this test system is that it is possible to apply potential pulse from the potential device 32 to the electrochromic device while measuring optical transmittance using the He—Ne laser 37 in real time.

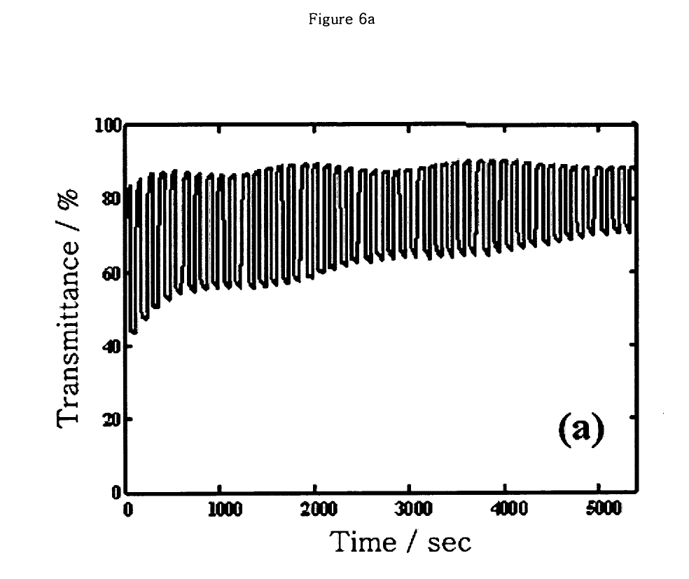

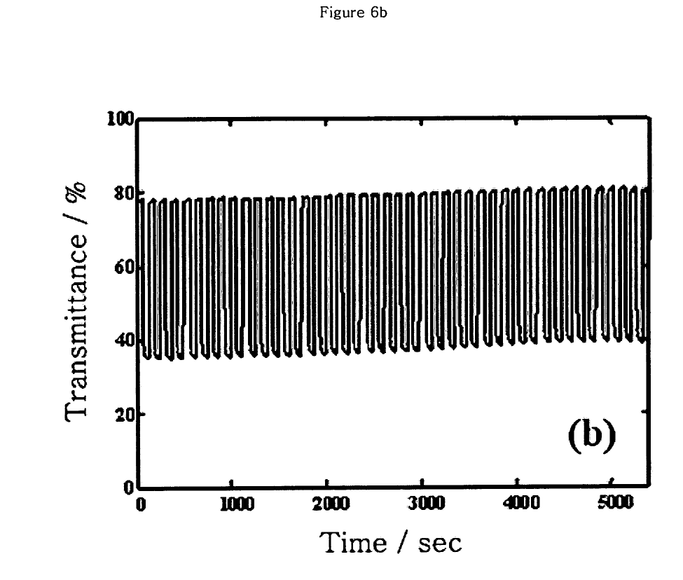

FIG. 6 shows changes in transmittance with pulse voltage for the electrochromic devices of Comparative Example and Example 1. As shown in FIG. 6a, the electrochromic device of Comparative Example showed a gradual decrease in transmittance with the progression of bleaching and coloring processes. This is because the intercalation and deintercalation reactions of electrolyte ions to both the electrodes irreversibly occur with the progression of cycles. Such irreversible intercalation and deintercalation reactions are believed to be because a small amount of water in the tungsten oxide thin film is modified into hydroxyl radicals which are then reacted with lithium ions to form lithium oxide (Li₂O) which is, in turn, accumulated in tungsten oxide. Thus, these irreversible reactions result in deterioration in the electrochromic properties and a reduction in the durability of the electrochromic device. On the other hand, as shown in FIG. 6b, the electrochromic device according to the present invention showed a constant change in transmittance (36%-78%) during the bleaching and coloring processes and had excellent durability.

The coloration efficiencies of the devices according to Comparative Example and Example 1 were measured and the results were 43 cm²/C and 70 cm²/C, respectively. Also, the bleaching response time and coloring response time of the electrochromic device according to Comparative Example were 10 seconds and 1.5 seconds, respectively, and the bleaching response time and coloring response time of the electrochromic device according to Example 1 were 1.25 seconds and 2.5 seconds, respectively, indicating that the bleaching and coloring response rates of the device of Example 1 are significantly faster than those of Comparative Example.

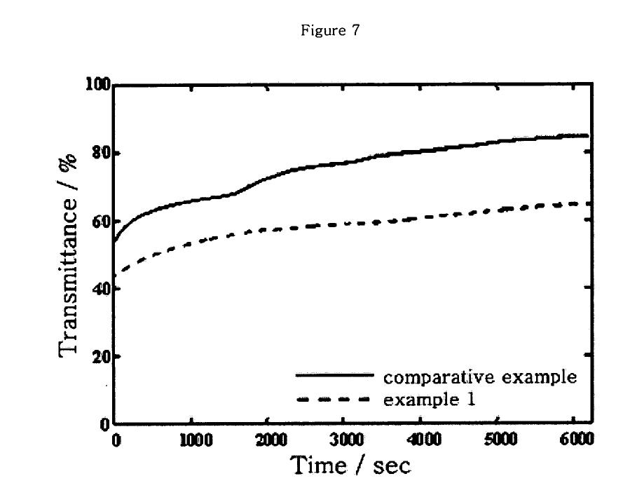

FIG. 7 shows the results of measurement of memory effect as a function of time in the electrochromic devices of Comparative Example and Example 1. The memory effect in electrochromic devices means that coloring resulted from the intercalation (or deintercalation) of charges into the electrochromic layer (or counterelectrode layer) is continuously maintained. It can be regarded that the higher the memory effect, the higher the energy saving effect, and accordingly, a high memory effect provides as a great advantage in electrochromic devices.

Each of the electrochromic devices according to Comparative Example and Example 1 was colorized at a coloring potential of −2.5 V for 30 seconds and then measured for optical transmittance with the He—Ne laser 37 without applying voltage. As shown in FIG. 7, the device of Comparative Example showed a rapid increase in optical transmittance upon the removal of coloring voltage, indicating that the device has low memory effect. This is believed to be because lithium ions intercalated into the electrochromic layer are spontaneously diffused to the bulk lithium ion-containing electrolyte layer due to the charge balance of the device, so that the electrochromic layer is returned to a bleached state. On the other hand, it can be seen that the device of Example had a slow change in optical transmittance, indicating high memory performance. This is believed to be because the protective inorganic solid electrolyte film according to the present invention prevents lithium ions intercalated into the electrochromic layer from being diffused into the bulk lithium ion-containing electrolyte layer.

### TEST EXAMPLE 4

The tungsten oxide thin film of Comparative Example and the tungsten oxide thin film of Example 2 including the protective inorganic solid electrolyte film (i.e., a device consisting of substrate (glass)/transparent electrode layer (ITO)/electrochromic layer (WO₃)/protective inorganic solid electrolyte film (LiPON)) were comparatively examined for electrochemical properties as a function of the thickness of the protective film.

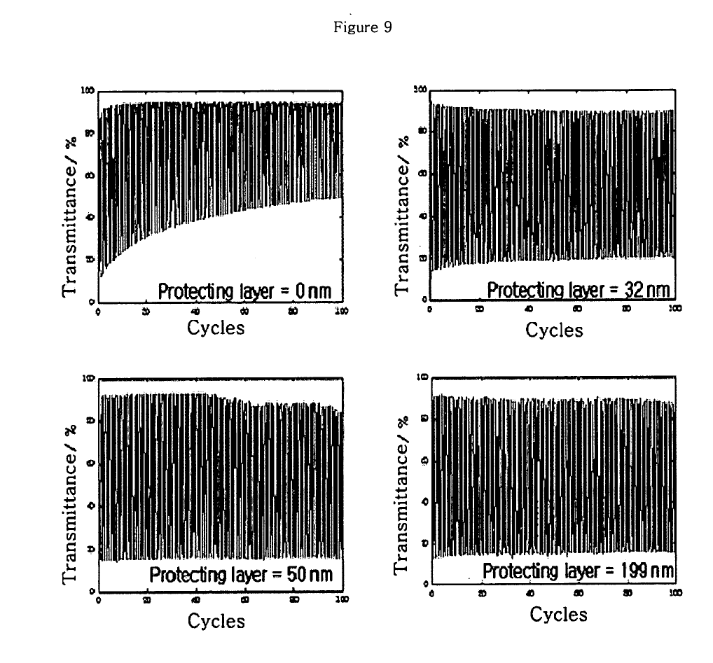

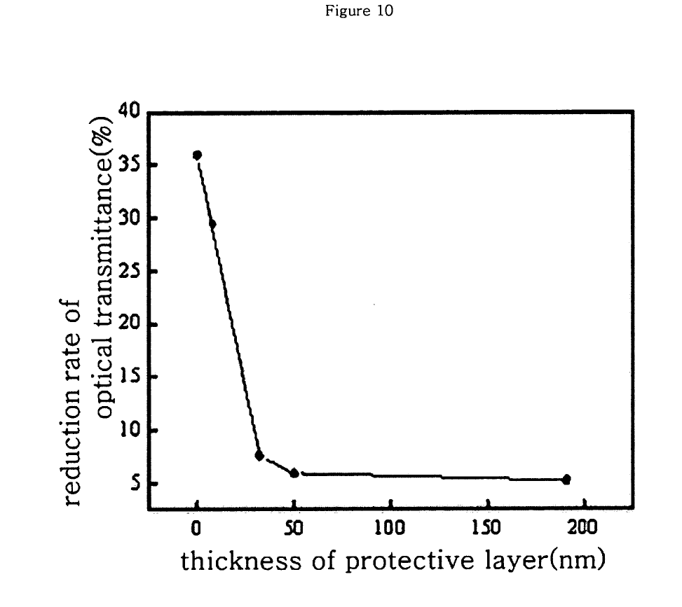

Changes in the optical transmittance of each of the devices were monitored according to the method described in Test Example 2, and the results are shown in FIG. 9. Also, the reduction rates of optical transmittance after one cycle and 100 cycles for each of the devices are shown in FIG. 10. As shown in FIGS. 9 and 10, the tungsten oxide thin film of Comparative Example having no protective inorganic solid electrolyte film showed a great reduction in optical transmittance (reduction rate of optical transmittance: 36%) with the progression of cycles. On the other hand, the tungsten oxide thin film of Example including the protective inorganic solid electrolyte film according to the present invention showed little or no change in optical transmittance, indicating that the electrochemical properties of the device were highly stable during the progression of cycles. Particularly in the case where the thickness of the protective inorganic solid electrolyte film was 30 nm or more, the reduction rate of optical transmittance was less than about 7%, suggesting a significant improvement in electrochemical stability (i.e., durability).

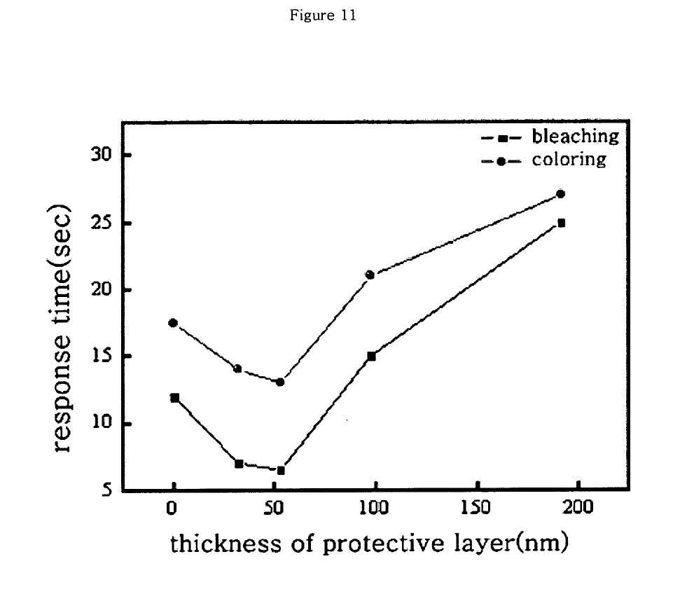

Furthermore, each of the devices was measured for bleaching response time and coloring response time, and the results are shown in FIG. 11. As shown in FIG. 11, it could be found that the thickness of the protective inorganic solid electrolyte film also had an important effect on the bleaching response time and coloring response time of the devices. Namely, in the case where the thickness of the protective inorganic solid electrolyte film was over 100 nm, the durability of the device was improved, but showed significant increases in bleaching response time and coloring response time compared to those of the tungsten oxide thin film having no protective inorganic solid electrolyte film, suggesting that the properties of the device were reduced.

The bleaching response time and coloring response time of electrochromism are very important characteristics required in application devices of electrochromic devices, particularly such as display devices. In these application devices, although electrochromic stability (i.e., durability) is also important, the thickness of the protective inorganic solid electrolyte film needs to be optimized to allow device characteristics, such as bleaching response time and coloring response time, to be realized together with an increase in stability (i.e., durability), because reductions in the response rates of electrochromic bleaching and coloration caused by the protective inorganic solid electrolyte film can act as the disadvantages of electrochromic devices.

As described above, in the inventive device comprising the protective inorganic solid electrolyte film, the electrochromic layer is not degraded or cracked by the electrolyte, leading to an increase in durability, unlike the prior device. Particularly, by using an optimized thickness of the protective inorganic solid electrolyte film, it is possible to increase the bleaching and coloring response rates of the electrochromic device to maximize the efficiency of the electromagnetic device.

As described above, the electrochromic device according to the present invention comprises the inorganic solid electrolyte as the protective film, and thus has excellent durability, fast bleaching and coloring response rates, and excellent memory effect with time. Accordingly, the present invention can be advantageously applied to a commercial process for manufacturing electrochromic devices. Particularly, the protective inorganic solid electrolyte film according to the present invention can reduce the interfacial resistance between the electrolyte and the electrodes and protect the working electrode from external physical or chemical invasion, and thus will be useful as a protective film for a working electrode in not only electrochromic devices, but also thin film battery cells, thin film fuel cells, dye-sensitized solar cells.

Although the preferred embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An electrochromic device comprising an electrochromic layer, an electrolyte layer and a counterelectrode layer, in which an inorganic solid electrolyte film as a protective layer is provided on the interface between the electrolyte layer and at least one layer of the electrochromic layer and the counterelectrode layer.

2. The electrochromic device of claim 1, wherein the inorganic solid electrolyte film is made of lithium phosphorus oxynitride (LiₓPO_{y}N_{z}).

3. The electrochromic device of claim 1, wherein the inorganic solid electrolyte film is formed by R-F magnetron sputtering.

4. The electrochromic device of claim 1, wherein the inorganic solid electrolyte film has a thickness of 30-100 nm.

5. The electrochromic device of claim 1, which comprises, with respect to the electrolyte layer, an inorganic solid electrolyte film, a counterelectrode layer, a transparent electrode layer and a substrate above the electrolyte layer, and an inorganic solid electrolyte film, an electrochromic layer, a transparent electrode layer and a substrate below the electrolyte layer.

6. The electrochromic device of Claim 1, wherein the electrolyte layer comprises a lithium ion-conducting electrolyte.

7. The electrochromic device of claim 1, wherein the counterelectrode layer comprises a coloring material selected from the group consisting of VₓO_{y}, NiₓO_{y}, IrₓO_{y}, FeₓO_{y}, MnₓO_{y}, RhₓO_{y} and CoₓO_{y} wherein x is 1-3, and y is 1-6.

8. The electrochromic device of claim 1, wherein the electrochromic layer comprises a coloring material selected from the group consisting of WₓO_{y}, MoₓO_{y}, TaₓO_{y}, NbₓO_{y}, TiₓO_{y} and CrₓO_{y} wherein x is 1-3, and y is 1-6.

9. A method for manufacturing an electrochromic device, comprising the steps of:
a) depositing an electrochromic layer on a substrate having a transparent electrode layer formed thereon and then depositing an inorganic solid electrolyte on the electrochromic layer by a sputtering process so as to form a protective film;
b) depositing a counterelectrode layer on a substrate having a transparent electrode layer formed thereon and then depositing an inorganic solid electrolyte on the counterelectrode layer by a sputtering process so as to form a protective film; and
c) injecting an electrolyte between the electrochromic layer and the counterelectrode layer, which comprise the protective inorganic solid electrolyte films formed in the steps a) and b), respectively, so as to form an electrolyte layer.

10. The method of claim 9, which additionally comprises, before the step of injecting the electrolyte between the two electrodes of the electrochromic device, the steps of injecting electrolyte ions into the electrochromic layer to colorize the electrochromic layer, and releasing electrolyte ions from the counterelectrode layer to colorize the counterelectrode layer.

11. The method of claim 9, which additionally comprises, before the step of injecting the electrolyte between the two electrodes of the electrochromic device, the steps of releasing electrolyte ions from the electrochromic layer to bleach the electrochromic layer, and injecting electrolyte ions into the counterelectrode layer to bleach the counterelectrode layer.
